(19) United States
(12) Patent Application Publication
(10) Pub. No.: US 2016/0004099 A1
(43) Pub. Date: Jan. 7, 2016

(54) Improvements in or Relating to the Manufacture of Variable Focus Fluid Lenses

(71) Applicant: ADLENS LIMITED, Oxford (GB)

(72) Inventors: Robert Stevens, Oxford (GB); Alex Edginton, Oxford (GB); Daniel Rhodes, Kidlington (GB); Julian Brandon-Jones, London (GB)

(21) Appl. No.: 14/768,668

(22) PCT Filed: Feb. 11, 2014
(86) PCT No.: PCT/GB2014/050394

§ 371 Date: Aug. 18, 2015

(30) Foreign Application Priority Data
Feb. 18, 2013 (GB) 1302800.6

(51) Int. Cl. G02C 7/08; G02C 7/06

(52) U.S. Cl. CPC G02C 7/085; G02C 7/06; G02C 2202/16

(57) ABSTRACT

A method of manufacturing a variable focus fluid lens assembly which includes mounting a membrane assembly within a recess formed in a lens housing said assembly including a distensible transparent membrane supported round its periphery by a supporting member and a flexible tubular wall having first and second opposite ends one of said ends being joined to the supporting member to form a cavity within the wall that is closed at the one end by the membrane; filling the cavity with a transparent fluid and fitting a transparent cover plate to the housing across the other end of the wall. The other end being joined sealingly to the cover plate or to the housing thereby to seal the cavity to form a compressible fluid-filled envelope. The cover plate may include a fixed lens selected from a stock of lenses having the same shape for fitting to the lens assembly, but different other optical properties, such for example as different base curves and/or decentration distances.

The present invention relates to the manufacture of variable focus fluid-filled lenses. In particular, the present invention provides a method for assembling fluid-filled lenses of the kind comprising a fixed prescription lens and a variable focus lens element that enables a range of lenses with different fixed prescription lenses to be provided whilst minimising the number of stock keeping units (SKUs) that are required to be kept by a manufacturer.

Variable focus fluid-filled lenses are disclosed in co-pending PCT/GB2012/051426 and PCT/EP2012/075549, the contents of which are incorporated herein by reference. Whilst the lenses disclosed by these applications may be constructed in a wide variety of different ways, in some of the specifically described embodiments, the lenses comprise a fluid-filled element that is accommodated within a lens housing that is closed by front and rear cover plates. At least one of the front and rear cover plates may comprise a fixed focus lens which operates in conjunction with the fluid-filled element to meet a patient's prescription for myopia, hyperopia or the like, while providing a degree of adjustability to eater additionally for presbyopia.

The fluid-filled element typically comprises a fluid-filled envelope, at least one wall of which is formed by a distensible transparent membrane that is supported round its periphery by a membrane supporting ring. The fluid-filled element is compressible for adjusting the pressure of the fluid within the envelope, thereby to control the shape of the membrane and adjust the power of the fluid-filled element. Whilst the fluid-filled elements of the lenses disclosed by PCT/GB2012/051426 and PCT/EP2012/075549 may be constructed in a wide variety of different ways, in some of the specifically described embodiments, the fluid-filled envelope comprises a flexible dish-shaped member, or bag, having a flexible side wall, a rear wall that is joined to an inner surface of the rear cover plate and a sealing flange at the front of the side wall that is joined round the membrane supporting ring to seal the envelope.

A fluid-filled lens of this kind can be manufactured by bonding the bag to the inner surface of the rear cover plate, filling the bag with fluid and then attaching the membrane-supporting member—with the distensible membrane fitted to the sealing flange on the side wall of the bag. The fluid-filled envelope may then be mounted within the recess in the housing, which is finally closed by attaching the front cover plate to protect the fluid-filled element.

Eyewear manufacturers generally wish to offer a range of different styles, each style having a different lens shape. For each lens shape, it is necessary to make available a range of different fixed prescription lenses, each one having a different base curve. As a minimum, it is desirable to offer at least three different base curves for each lens shape. On top of this, for each base curve, it is necessary to provide a range of different decentrations (to cater for different centration distances). For each lens shape therefore it is desirable to provide a large number of variants in terms of base curve and decentration. The number of different variations increases in proportion to the number of different styles.

By mounting the dish-shaped member of the lenses of kind disclosed specifically by PCT/GB2012/051426 and PCT/EP2012/075549 on the rear cover plate, which is a fixed prescription lens, at an early stage during the manufacturing process, there is a requirement to keep a large number of different SKUs, pending receipt of actual orders. That is to say, the manufacturer must keep in stock a complete range of fluid-filled lenses with different rear cover plates in order to supply any given order.

It is an object of the present invention to provide an improved manufacturing process for fluid-filled lenses of this kind and, in particular, to minimise the number of SKUs that an eyewear manufacturer must keep in stock to be able to supply a complete range of lenses.

In accordance with the present invention there is provided a method of manufacturing a variable focus fluid lens which comprises mounting a membrane assembly within a recess formed in a lens housing, said assembly comprising a distensible transparent membrane supported round its periphery by a supporting member and a flexible tubular wall having first and second opposite ends, one of said ends being joined to the supporting member to form a cavity within the wall that is closed at the one end by the membrane; filling the cavity with a transparent fluid; and fitting a transparent cover plate to the housing across the other end of the wall, said other end of the tubular wall being joined sealingly to the cover plate or to the housing, thereby to seal the cavity to form a compressible fluid-filled envelope.

In some embodiments, said cover plate may have an arcuate inner surface that is disposed on the inside of the cavity when the cover plate is fitted. Said inner surface may be convex or concave. Suitably the inner surface is convex, protruding into the cavity when the plate is fitted. Said cover plate may comprise a lens having some optical power. The lens may have a planar or arcuate outer surface that is disposed outside the cavity when the plate is fitted. In some embodiments, the lens may have a convex inner surface and a concave outer surface to form a meniscus lens of some optical power.

Advantageously, in accordance with the present invention, the cover plate is fitted at a relatively late stage during the assembly process, after mounting the membrane assembly within the lens housing. In some embodiments, the cavity may be filled with fluid after fitting the cover plate, but alternatively the cavity may be filled before the cover plate is attached. In either case, this means that the lenses can be partially assembled, and then filled and fitted with a cover plate when required. In particular, a cover plate may be fitted which is a fixed lens having the desired physical and optical properties selected from a range of alternative lenses having the same boundary shape for fitting to the lens assembly, but other different characteristics, such as different base curves, different decentration distances, different coatings etc. This allows the manufacturer to minimise the number of SKUs that must be kept to supply lens assemblies incorporating a wide range of different fixed prescription lenses.

In accordance with the invention therefore a stock of different cover plates may be provided, each being correctly shaped and dimensioned for attachment to the lens housing, but having respective different characteristics, such as different base curves, decentration distances or the like, and the method of the invention comprises selecting one of the cover plates from the stock.

Advantageously, each of the different cover plates within the stock may have an inner surface of the same shape, so that each of the different cover plates can be fitted to the lens assembly in the same way, without having to amend the assembly process. For instance, each of the different cover plates may have the same shaped concave inner surface which will displace the same amount of fluid within the cavity. Regardless of the cover plate that is selected for fitting to the lens assembly therefore the cavity can be filled with the same volume of fluid to produce the desired neutral membrane shape. By “neutral membrane shape” herein is meant the shape the membrane adopts when the cavity is filled with a predetermined volume of fluid at ambient pressure, with the cover plate fitted and the membrane assembly mounted within the recess in the lens housing. The neutral membrane shape usually corresponds to minimum curvature of the membrane, the membrane becoming more curved when the lens is actuated by increasing the pressure of the fluid. Suitably the neutral membrane shape may be substantially flat, or it may be curved in the same direction as the inner surface of the cover plate. In this way, the membrane and the outer surface of the cover plate may in some embodiments form a meniscus lens to minimise the thickness of the assembly for a given nominal power. Said neutral membrane shape may be similar to the typical meniscus curve found in fixed lenses of the same nominal power.

In accordance with the invention, the cover plate is fitted to the lens housing to close the cavity. Suitably, the cover plate and lens housing may be fabricated with mutually engaging surfaces to ensure the cover plate is correctly located and fitted to the lens housing. In some embodiments, the lens housing may define an opening, and the cover plate may be shaped and dimensioned to form a close fit within the opening. Alternatively, the cover plate may abut an outer surface of the lens housing. Suitably, the lens housing and cover plate may be formed with inter-engaging surfaces or other formations to locate the cover plate in the correct position. A seal may be provided between the cover plate and the lens housing. Said seal may be formed by one or more sealing parts. Where a stock comprising a plurality of different cover plates is provided as described above, each of the different cover plates may comprise a similar engaging surface or formations for inter engagement with the lens housing, so that irrespective of which cover plate is selected for mounting to the lens housing, the cover plate is always fitted in the same position and/or engaged with the same sealing parts.

In some embodiments, after filling and fitting the cover plate to the housing to seal the cavity, the volume of fluid within the cavity may be adjusted to calibrate the lens assembly. In particular, the lens assembly may be calibrated such that the membrane adopts a predetermined resting shape, with all of the other parts of the assembly in a predetermined configuration.

For this purpose, after fitting the cover plate, fluid may be added to or taken away from the cavity through a needle inserted into the cavity, for instance through a sealable aperture in the membrane, tubular wall or cover plate. Alternatively, the lens housing may comprise a small separate reservoir of fluid that is connected to the cavity via a suitable conduit, and an adjuster may be provided for expelling fluid from the reservoir into the cavity, or for withdrawing fluid from the cavity into the reservoir in order to adjust finely the volume of fluid within the cavity. Once the lens assembly has been correctly calibrated, the adjuster may be locked, for instance irreversibly locked, to prevent further adjustment. Alternatively, the reservoir and conduit may be removed, or the adjuster may be removed. In a further embodiment, the conduit may be severed or disconnected from the cavity.

Where the lens assembly is incorporated into eyeglasses of the kind comprising two frames. interconnected by a bridge piece and two temples, the reservoir may be accommodated within the frames, bridge piece or temples of the eyeglasses outside the field of view. Since only a small amount of fluid is needed to provide fine adjustment/calibration of the volume of fluid within the cavity, the reservoir may be small and can be easily concealed within the lens housing or within other parts of the eyeglasses such as those just mentioned.

In some embodiments, the cavity may be filled with fluid through ports in the tubular wall. This may be especially useful when the cover plate is fitted before the cavity is filled. In some embodiments, the final volume of fluid within the cavity can be adjusted by controlling the amount of fluid that is admitted to the cavity through the ports.

Alternatively, the cavity can be filled with fluid before fitting the cover plate, in which case the fluid can be dispensed directly into the cavity, for example from a suitable filling machine. For this purpose, the lens assembly may be held with the membrane and its encircling supporting member lowermost and the tubular wall extending upwards from the supporting member, in the manner of a dish. Typically this may be done under vacuum. After filling the cavity, the cover plate is fitted to the housing to seal the cavity. Thereafter the lens assembly may be reoriented to any desired orientation.

In some embodiments, the fluid filled element of the lens assembly comprises an adjustable volume lens, for example a compression lens, where the shape of the membrane is controlled by adjusting the volume of the cavity, thereby to adjust the pressure of the fluid within the cavity. To this end, the membrane and membrane supporting member are mounted movably within the recess of the lens housing such that the membrane supporting member can be displaced relative to the lens housing and cover plate for adjusting the volume of the cavity. The membrane supporting member may be coupled to the lens assembly at discrete control points round the supporting member. Said control points may comprise hinge points where the supporting member is held at a fixed position relative to the lens housing and/or actuation points where the supporting member can be moved relative to the lens housing for compressing (or expanding) the cavity for adjusting the fluid pressure in the cavity. In the case of an adjustable volume lens, at least one of the control points should comprise an actuation point for compressing or expanding the cavity.

Suitably, the fluid filled element of the lens assembly may comprise a fluid filled lens of the kind disclosed by PCT/GB2012/051426 or PCT/EP2012/075549.

Suitably, the membrane supporting member may comprise a ring. In some embodiments, the ring may be bendable and, in accordance with PCT/GB2012/051426 or PCT/EP2012/075549, the bending stiffness of the ring may vary round at its extent to control the shape of the membrane when the pressure of the fluid within the cavity is adjusted to cause the membrane to distend convexly or concavely.

Advantageously, in some embodiments, the lens assembly of the invention may comprise a second cover plate that is fitted to the lens housing over the membrane assembly on the opposite side from the fluid-filled cavity in order to protect the membrane assembly. In some embodiments, the second cover plate may also comprise a lens having some optical power or components of a progressive lens.

Suitably the pair of cover plates may be selected with regard for one another to achieve a suitable cavity between them to accommodate the fluid-filled lens element at every state of distension of the membrane. Dependent on this, the pair of cover plates may be selected to minimise the thicknesses of the lens possible with the mechanical and fluidic displacement of the fluid filled lens actuation at multiple points across the lens assembly simultaneously. Thus, the inner surfaces of the respective cover plates may be selected to match closely the envelope of the fluid-filled element.

In some embodiments, the external surface of one or both of the cover plates may be adapted to include known optical corrections for the improvement of thick or doublet lenses.

The present invention also comprehends a lens assembly that is manufactured in accordance with the process of the invention. Said lens assembly may comprise a lens module for eyeglasses. In yet another aspect of the invention there is provided an article of eyewear comprising at least one lens assembly in accordance with the invention.

Following is a description by way of example only with reference to the accompanying drawings of embodiments of the present invention:

In the drawings:

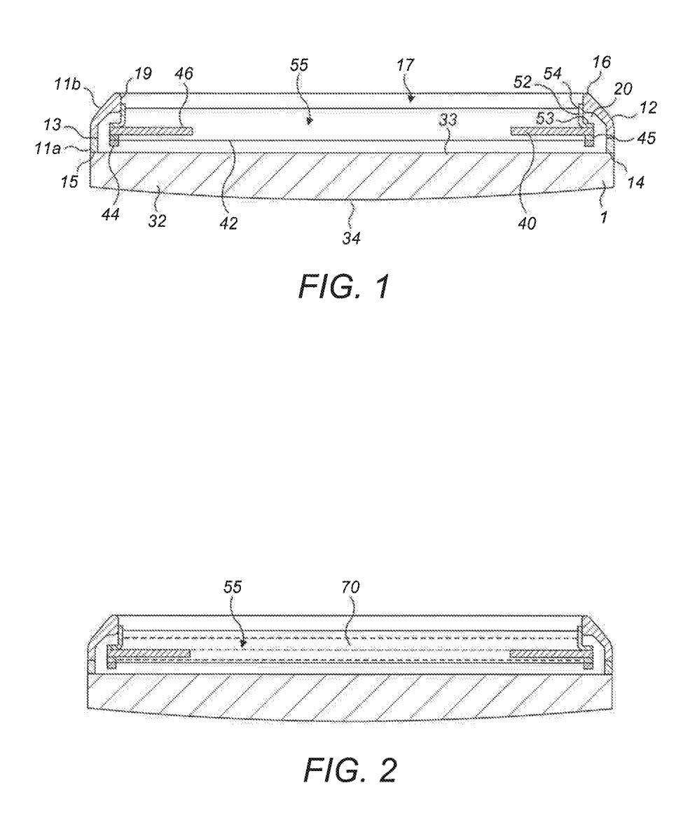

FIG. 1 is a cross-section of a partially assembled lens assembly in accordance with the invention before filling with fluid and fitting the cover plate.

FIG. 2 is a cross-section of the partially assembled lens assembly of FIG. 1, in which the cavity is filled with fluid.

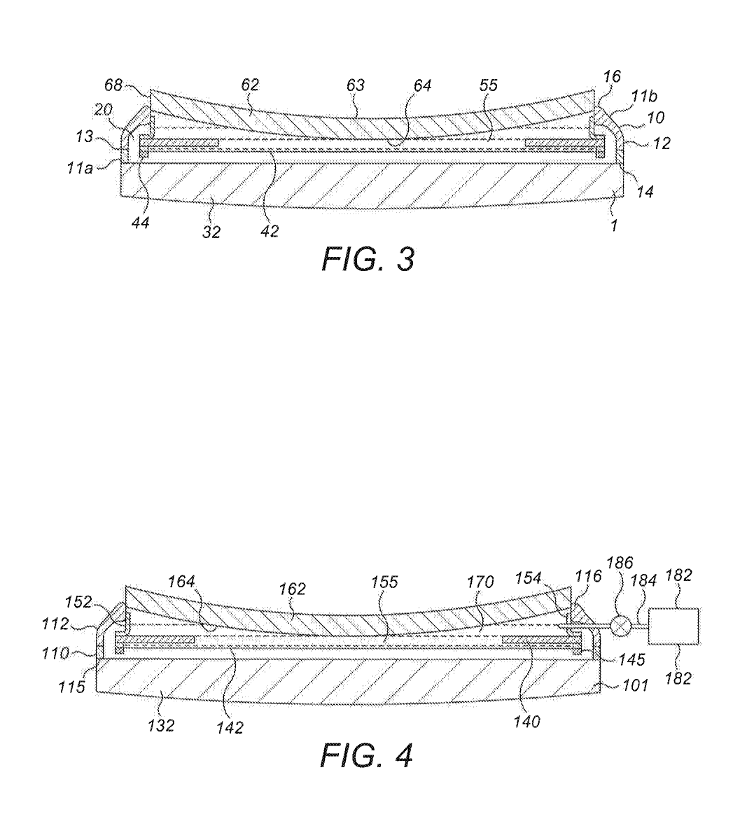

FIG. 3 is a cross-section of the lens assembly of FIGS, 1 and 2 with the cover plate fitted.

FIG. 4 is a cross-section of a lens assembly in accordance with another embodiment of the invention which comprises a separate fluid reservoir for adjusting and calibrating the lens assembly.

With reference to FIG. 1, a lens assembly 1 in accordance with the present invention comprises a lens housing 10 having a substantially rigid peripheral sidewall 12 that defines and surrounds an internal recess 20. The sidewall 12 has a front end 14 and a rear end 16, and comprises a front part 11a and a rear part 11b that are joined at circumferential joint 13. The front part 11a defines an annular front surface 15 at the front end 14 of the sidewall 12, and the rear part 11b is formed with an opening 17 having an inner surface 19.

The front part 11a is bonded to an optically transparent front cover plate 32 having an inner rear surface 33 and an outer front surface 34. In the embodiment shown, the inner rear surface 33 is substantially planar, while the outer front surface is convex, such that the cover plate 32 is a lens of fixed focal power. However, in other embodiments, the front and rear surfaces of the cover plate 32 may have different profiles and, in particular, in some embodiments they may both be flat and parallel, such that the front cover plate is non-lensing. The front cover plate 32 is bonded by means of a suitable adhesive to the annular front surface 15 at the front and 14 of the sidewall 12. In this way, the front cover plate 32 is sealed to the sidewall 12.

The recess 20 within the sidewall 12 accommodates a membrane assembly 40 comprising a transparent elastic membrane 42 that is carried by a peripheral membrane supporting member 44 which consists of two or more flexible rings 45 that sandwich the membrane 42 therebetween and a generally annular bending control disk 46 that is bonded to a rear face of the rings 45 as shown in FIG. 1. Suitably, the membrane 42 may be tensioned on the rings 45 to prevent sagging or wrinkling of the membrane 42. The rings 45 may be coupled to the sidewall 12 of the lens housing 10 by means of small radial tabs (not shown) that are trapped in the joint 13 between the front and rear parts 11a, 11b of the sidewall. In this way, the membrane supporting member 44 is hinged at discrete locations around its extent to the sidewall 12. In addition, the membrane supporting member 44 is connected to a suitable actuator for controllably displacing the membrane supporting member 44 relative to the sidewall 12 in a manner described in more detail below.

The construction and arrangement of the membrane supporting member 44 and its coupling to the lens housing 10 is described in more detail in PCT/GB2012/051426 and PCT/EP2012/075549, and for the purposes of the present description is unnecessary to go into more detail about that.

Attached to the rear face of the bending control disk 46 is a flexible tubular sidewall 52 having a sealing flange 53 at its front end, which is bonded to the rear face of the bending control disk 46, and a rear end 54 which is bonded to the rear end 16 of the sidewall 12. The tubular sidewall 52 and the membrane 42 form a cavity 55.

In accordance with the present invention, the lens assembly 1 is manufactured by assembling the sidewall 12, front cover plate 32 and the membrane assembly 40 as shown in FIG. 1. Generally, for a range of different lens assemblies, all of the components described so far for the partially assembled lens assembly will be similar.

In order to complete the lens assembly 1, the cavity 55 must be filled with a transparent fluid, and a rear cover plate 62 must be fitted, which rear cover plate 62 comprises a lens having some optical power. For a range of different lens assemblies of the same basic lens shape, it is necessary to offer a range of different optical powers of the rear cover plate 62; that is rear cover plates 62 having different base curves. Further, for each respective base curve, it is desirable to offer a range of lens assemblies 1 with different decentration distances. For this purpose therefore a stock of different rear cover plates 62, all of which are suitable for assembly with the partially assembled lens assembly 1, are provided. Within the stock of different rear cover plate 62, there are a range of different base curves and decentration distances.

As best shown in FIG. 3, each rear cover plate 62 comprises a substantially rigid, optically transparent sheet having a front surface 64 and a rear surface 63. The rear cover plate 62 has a peripheral sidewall 68 that is shaped and dimensioned to form a close fit within the opening 19 in the rear end 16 of the sidewall 12 the lens housing 10. In the embodiment shown, the front surface 64 is convex, such that it protrudes into the cavity 55 when fitted. The rear surface 63 is concave. The rear cover plate 62 thus forms an optically transparent lens of some optical power and, in the embodiment shown in the drawings, the rear cover plate 62 is a meniscus lens. In accordance with the invention, the stock of different rear cover plates 62 mentioned above all have the same shape of front surface 64, but a range of different rear surface shapes 63 to provide different base curves and different decentration distances.

When an order for a lens assembly is received, the partially assembled lens assembly 1 shown in FIG. 1 may be finished by filling the cavity 55 with an optically transparent fluid 70 as shown in FIG. 2 and then fitting a rear cover plate 62 of the appropriate base curve and decentration distance selected from the stock, as shown in FIG. 3. In the present embodiment, the cavity 55 is filled with fluid 70, before fitting the rear cover plate 62 and, for this purpose, the partially assembled lens assembly 1 may be oriented with the front cover plate 32 facing downwards as shown in FIG. 1 such that the membrane 42 and tubular sidewall 54 form a dish-shaped receptacle for receiving the fluid, which may be dispensed into the cavity 55 by means of a suitable filling machine. Suitably, this filling step is carried. out under vacuum. In some embodiments, the membrane 42 may be supported under its front surface during the filling step to prevent sagging of the membrane.

After filling the cavity 55 with a predetermined volume of fluid 70, the rear cover plate 62 is fitted as shown in FIG. 3, such that the convex front surface 64 of the rear cover plate 62 protrudes into the cavity 55, which causes displacement of the fluid 70. The inner surface 19 of the sidewall 12 and the outer surface 68 of the rear cover plate 62 may be formed with inter-engaging formations (not shown) to ensure that the rear cover plate 62 is inserted into the rear end 16 of the sidewall 12 and located in the correct position. The rear cover plate 62 is then bonded by means of a suitable adhesive to the sidewall 12 around the joint between the surfaces 19 and 68. In this way, the rear cover plate 62 is sealed to the sidewall 12 to form a closed lens assembly.

Since all of the rear cover plates 62 within the stock of cover plates have the same shape of front surface 64, the displacement of fluid 70 caused by the insertion of the rear cover plate 62 is the same regardless of which rear cover plate 62 is selected for dispensing. In this way, the same manufacturing process can be performed, without adjustment, for any selected rear cover plate 62. The volume of fluid 70 dispensed into the cavity 55 should be calculated, taking into account the displacement of the fluid by the rear cover plate 62, so that in the fitted position the pressure of the fluid 70 within the cavity 55 has a predetermined value, so that the membrane 42 has a required form.

Nevertheless, a degree of adjustment of the volume of fluid 70 within the cavity 55 may be desirable in some embodiments to provide fine control over the membrane shape. In an alternative embodiment as shown in FIG. 4, therefore, a lens assembly 101 is provided with an adjuster 180 for adjusting the volume of fluid within the cavity after filling and closing the cavity. The lens assembly 101 is basically similar to the lens assembly 1 of the first embodiment described above, and is therefore not described in detail herein, but in FIG. 4 parts of the lens assembly 101 that correspond to similar parts of the lens assembly 1 are indicated using similar reference numerals that are simply incremented by 100.

The adjuster 180 comprises a reservoir 182 containing the same fluid 170 that is used to fill the cavity 155 within the lens housing 110. The reservoir 182 communicates with the cavity 155 via a tube 184 that is fitted with a controller 186 for controlling the injection or withdrawal of fluid 170 from the cavity 155. By operating the controller 186, small amounts of fluid 170 can be added to or subtracted from the body of fluid 170 within the cavity 155 in order to make fine adjustments to the volume of fluid within the cavity 155 and therefore to the shape of the membrane 142. Once the volume of fluid 155 within the cavity 170 has been adjusted, the adjuster 180 may be removed. Alternatively, the controller 186 could be locked to prevent further adjustment. In yet a further alternative, the tube 184 may be severed or blocked. In these ways, the volume of fluid 170 within the cavity 155 is “set and sealed”.

In an alternative method in accordance with the invention, the lens assembly 1 of the first embodiment described above may be made by fitting the rear cover plate 62 to the sidewall 12 prior to filling the cavity 55 with fluid 70, in which case the fluid 70 may be injected into the cavity 55 through suitable apertures formed in the front cover plate 32, sidewall 12 or rear cover plate 62. The injection of fluid 70 in this manner is controlled such that a predetermined volume of fluid 70 is admitted into the cavity 55 to provide a predetermined fluid pressure and membrane form.

After filling and closing, and any final adjustment and calibration, the lens assembly 1; 101 is ready for use. The lens assembly 1; 101 provides a combination of a fixed lens 62; 1.62 with a fluid filled element consisting of the membrane assembly 40; 140 and the fluid 70; 170. As described above, the membrane assembly 40; 140 is coupled to an actuator (not shown) for displacing the rings 45; 145 within the lens housing 10; 110 for adjusting the volume of the cavity 55; 155. By adjusting the volume of the cavity 55; 1.55, the fluid pressure within the cavity 55; 155 is altered, allowing the shape of the membrane 42; 142 to be controlled. In particular, by compressing the cavity 55; 155 by displacing the rings 45; 145 rearwards within the housing 10; 110, the volume of the cavity 55; 155 may be reduced, thereby increasing the pressure of the fluid within it and causing the membrane 42; 142 to distend forwards, increasing the focal power of the fluid element. It will be understood that the membrane assembly 40; 140 it should be hinged to the lens housing sidewall 12; 112 in the manner described above at locations that do not impede selective displacement of the membrane supporting member 44; 144 as described above for controlling the shape of the membrane. The tubular sidewall 52; 152 of the membrane assembly 40; 140 is flexible to allow compression (or expansion) of the cavity.

As described above, the tubular sidewall 52; 152 is bonded to the rear end 16; 116 of the sidewall 12; 112. However, in an alternative embodiment, the rear end and 54; 154 of the tubular sidewall 52; 152 may be bonded to the rear cover plate 62; 162.

1. A method of manufacturing a variable focus fluid lens assembly, the method comprising:
mounting a membrane assembly within a recess formed in a lens housing, said membrane assembly comprising a distensible transparent membrane supported round its periphery by a supporting member and a flexible tubular wall having first and second opposite ends, one of said ends being joined to the supporting member to form a cavity within the wall that is closed at the one end by the membrane;
filling the cavity with a transparent fluid; and
fitting a transparent cover plate to the housing across the other end of the wall, said other end being joined sealingly to the cover plate or to the housing, thereby to seal the cavity to form a compressible fluid-filled envelope.

2. The method as claimed in claim 1, wherein said cover plate has an arcuate inner surface that is disposed on the inside of the cavity when the cover plate is fitted.

3. The method as claimed in claim 2, wherein said inner surface is convex or concave.

4. The method as claimed in claim 1, wherein said cover plate comprises a lens having some optical power.

5. The method as claimed in claim 1, wherein the cavity is filled with fluid after fitting the cover plate.

6. The method as claimed in claim 1 wherein the cavity is filled before the cover plate is attached.

7. The method as claimed claim 1, further comprising selecting the cover plate from a stock of lenses having the same boundary shape for fitting to the lens assembly, but different other optical properties.

8. The method as claimed in claim 7, wherein the lenses within the stock are all similarly shaped and dimensioned for attachment to the lens housing, but having different respective base curves and/or decentration distances.

9. The method as claimed in claim 7, wherein each of the different cover plates within the stock has an inner surface of the same shape.

10. The method as claimed in claim 1, wherein the outer surface of the cover plate is concave, its inner surface is convex and the membrane has a convex neutral form at ambient pressure so as to form a meniscus lens with the outer surface of the cover plate.

11. The method as claimed in claim 1, further comprising adjusting the volume of fluid within the cavity after filling and fitting the cover plate to the housing to calibrate the lens assembly.

12. The method as claimed in claim 11, wherein said adjusting step comprises adding or removing fluid from the cavity through a needle inserted into the cavity.

13. The method as claimed in claim 11, wherein the lens housing comprises a separate reservoir of fluid that is connected to the cavity via a conduit, and an adjuster is provided for expelling fluid from the reservoir into the cavity, or for withdrawing fluid from the cavity into the reservoir in order to adjust finely the volume of fluid within the cavity.

14. The method as claimed in claim 13, wherein once the lens assembly has been correctly calibrated, the adjuster may be locked or removed to prevent further adjustment.

15. The method as claimed in claim 1 wherein the cavity is filled with fluid before fitting the cover plate.

16. The method as claimed in claim 15, wherein the cavity is filled under vacuum.

17. The method as claimed in claim 1, wherein the membrane supporting member comprises a bendable ring.

18. The method as claimed in claim 1 further comprising fitting a second cover plate to the lens housing over the membrane assembly on the opposite side from the fluid-filled cavity.

19. The method as claimed in claim 17, wherein the second cover plate comprises a lens having some optical power.

20. The method as claimed in claim 18, wherein the first cover plate and the second cover plate have arcuate inner surfaces that are disposed on the inside of the cavity when the first cover plate and second cover plate is fitted, wherein the shapes of the inner surfaces of both cover plates are selected to minimize the thickness of the lens assembly.

21. The method as claimed in claim 1, wherein the cover plate has an outer surface that is adapted to include an optical correction for the improvement of thick or doublet lenses.

22. The method as claimed in claim 18, wherein one or both of the cover plates has an outer surface that is adapted to include an optical correction for the improvement of thick or doublet lenses.

23. A lens assembly that is made in accordance with a method of manufacturing a variable focus fluid lens assembly, the method comprising:
mounting a membrane assembly within a recess formed in a lens housing, said membrane assembly comprising a distensible transparent membrane supported round its periphery by a supporting member and a flexible tubular wall having first and second opposite ends, one of said ends being joined to the supporting member to form a cavity within the wall that is closed at the one end by the membrane;
filling the cavity with a transparent fluid; and
fitting a transparent cover plate to the housing across the other end of the wall, said other end being joined sealingly to the cover plate or to the housing, thereby to seal the cavity to form a compressible fluid-filled envelope.

24. The lens assembly as claimed in claim 23, wherein said lens assembly comprises a lens module for eyeglasses.

25. An article of eyewear comprising at least one lens assembly made in accordance with a method of manufacturing a variable focus fluid lens assembly, the method comprising:
mounting a membrane assembly within a recess formed in a lens housing, said membrane assembly comprising a distensible transparent membrane supported round its periphery by a supporting member and a flexible tubular wall having first and second opposite ends, one of said ends being joined to the supporting member to form a cavity within the wall that is closed at the one end by the membrane;
filling the cavity with a transparent fluid; and
fitting a transparent cover plate to the housing across the other end of the wall, said other end being joined sealingly to the cover plate or to the housing, thereby to seal the cavity to form a compressible fluid-filled envelope.
